(19) United States
(12) Patent Application Publication
(10) Pub. No.: US 2026/0106194 A1
(43) Pub. Date: Apr. 16, 2026

(54) FUEL CELL DURABILITY OPTIMIZATION

(71) Applicant: GM Global Technology Operations LLC, Detroit, MI (US)

(72) Inventors: Xiaofeng Wang, Troy, MI (US); Chad Dubois, Oxford, MI (US); Manish Sinha, St. Petersburg, FL (US); Sergio Eduardo Garcia, Commerce Township, MI (US); Biju Edamana, Christiansburg, VA (US)

(21) Appl. No.: 18/915,997

(22) Filed: Oct. 15, 2024

(51) Int. Cl. H01M 8/04955; H01M 8/04303; H01M 8/04664; H01M 8/04746

(52) U.S. Cl. CPC H01M 8/04955; H01M 8/04303; H01M 8/04671; H01M 8/04761; H01M 2250/20

(57) ABSTRACT

A method of controlling a hydrogen fuel cell includes, with a controller of the fuel cell, measuring an anode leak rate for the fuel cell, modelling, using the measured anode leak rate, an effective electrolyte membrane orifice size, calculating, using the effective electrolyte membrane orifice size, an effective runtime anode leak rate during operation of the fuel cell, using the effective runtime anode leak rate as a low-side metric when calculating emissions and dilution requests, and initiating adaptations of a control strategy of the fuel cell based on the effective runtime anode leak rate and shutdown leak rate to extend the lifetime of the fuel cell.

### INTRODUCTION

The present invention relates generally to fuel cells, and particularly to control systems for fuel cells. In some applications fuel cells are designed wherein the fuel and oxidant supply streams are flow-through systems, however, these systems add a parasitic load to the fuel cell output and thus reduce the net power that can be extracted. In other configurations the fuel stream or the oxidant stream or both are “dead-ended”. This dead-ended operation creates issues such as water removal and accumulation of impurities. Further, degradation of the electrolyte membrane separating the anode and the cathode negatively impacts the fuel cell, and generally is an indication of end of life for a fuel cell.

Thus, there is a need for an improved fuel cell, fuel cell propulsion system and method of controlling a fuel cell, wherein the operating parameters of the fuel cell are modified based on an effective leak rate of the electrolyte membrane, allowing extended lifetime of the fuel cell when leakage across the electrolyte membrane is present.

### SUMMARY

According to several aspects of the present disclosure, a method of controlling a hydrogen fuel cell includes, with a controller of the fuel cell, measuring an anode leak rate for the fuel cell, modelling, using the measured anode leak rate, an effective electrolyte membrane orifice size, calculating, using the effective electrolyte membrane orifice size, an effective runtime anode leak rate during operation of the fuel cell based on the current operating conditions, using the effective runtime anode leak rate as a low-side metric when calculating emissions and dilution requests, and initiating adaptations of a control strategy of the fuel cell based on one of the effective runtime anode leak rate, or a shutdown leak rate.

According to another aspect, the measuring an anode leak rate for the fuel cell further includes measuring an anode shutdown leak rate for the fuel cell.

According to another aspect, the measuring an anode leak rate for the fuel cell further includes monitoring pressure decay within the anode during low-power operation of the fuel cell; and at least one of estimating the anode leak rate based on the pressure decay within the anode during low-power operation of the fuel cell, and calculating the anode leak rate based on both anode pressure change and cathode pressure change.

According to another aspect, the initiating adaptations of the control strategy of the fuel cell based one of the effective runtime anode leak rate or the shutdown leak rate further includes, during start-up of the fuel cell, increasing a duration of increased air flow through a cathode of the fuel cell to dilute the concentration of hydrogen leaked from the anode, wherein, anode to cathode bias pressure, air flow rate, air flow split and the duration of increased air flow are calculated and adjusted based on one of the effective runtime anode leak rate, or the shutdown leak rate.

According to another aspect, the initiating adaptations of the control strategy of the fuel cell based on one of the effective runtime anode leak rate or the shutdown leak rate further includes adapting, during run-time operation of the fuel cell, bleed request frequency to vent gas from the anode of the fuel cell.

According to another aspect, the initiating adaptations of the control strategy of the fuel cell based on one of the effective runtime anode leak rate or the shutdown leak rate further includes increasing, during run-time operation of the fuel cell, airflow through the cathode to compensate for the oxygen consumed by hydrogen gas that permeates through the electrolyte membrane.

According to another aspect, the initiating adaptations of the control strategy of the fuel cell based on one of: the effective runtime anode leak rate or the shutdown leak rate further includes limiting, during run-time operation of the fuel cell, transient load rates to control emissions during and after power load fluctuations.

According to another aspect, the initiating adaptations of the control strategy of the fuel cell based on one of: the effective runtime anode leak rate or the shutdown leak rate further includes, during run-time operation of the fuel cell, at least one of reducing bleed frequency, increasing airflow through the cathode to compensate for the oxygen consumed by hydrogen gas that permeates through the electrolyte membrane, and limiting transient load rates to control emissions during and after power load fluctuations.

According to another aspect, the initiating adaptations of the control strategy of the fuel cell based on one of: the effective runtime anode leak rate or the shutdown leak rate further includes, during a shutdown operation of the fuel cell, venting hydrogen gas from the anode and the cathode directly to exhaust, and reducing the anode and cathode pressure.

According to another aspect, the initiating adaptations of the control strategy of the fuel cell based on one of: the effective runtime anode leak rate or the shutdown leak rate further includes, during a freeze start operation of the fuel cell, reducing bias pressure between the anode and the cathode.

According to another aspect, the initiating adaptations of the control strategy of the fuel cell based on one of: the effective runtime anode leak rate or the shutdown leak rate further includes during a stand-by operation of the fuel cell, continuously, on a periodic basis, monitoring pressure decay within the anode, and during an extended period of non-use, initializing H2-in-park measures to ensure that sufficient hydrogen gas remains present within the anode and cathode for a start-up operation when pressure decay within the anode indicates that oxygen has leaked into the anode.

According to another aspect, the method further includes updating the measured anode leak rate whenever power output of the fuel cell is zero.

According to several aspects of the present disclosure, a fuel cell includes an anode, a cathode, an electrolyte membrane positioned between the anode and the cathode, and a controller adapted to measure an anode leak rate for the fuel cell and update the measured anode leak rate whenever power output of the fuel cell is zero, model, using the measured anode leak rate, an effective electrolyte membrane orifice size, calculate, using the effective electrolyte membrane orifice size, an effective runtime anode leak rate during operation of the fuel cell, use the effective runtime anode leak rate as a low-side metric when calculating emissions and dilution requests, and initiate adaptations of a control strategy of the fuel cell based on one of the effective runtime anode leak rate, or a shutdown leak rate.

According to another aspect, when measuring the anode leak rate for the fuel cell, the controller is further adapted to measure an anode shutdown leak rate for the fuel cell.

According to another aspect, when measuring the anode leak rate for the fuel cell, the controller is further adapted to monitor pressure decay within the anode during low-power operation of the fuel cell, and estimate the anode leak rate based on the pressure decay within the anode during low-power operation of the fuel cell.

According to another aspect, when initiating adaptations of the control strategy of the fuel cell based on one of: the effective runtime anode leak rate or the shutdown leak rate, the controller is further adapted to, during start-up of the fuel cell, increase a duration of increased air flow through a cathode of the fuel cell to dilute the concentration of hydrogen leaked from the anode, wherein, anode to cathode bias pressure, air flow rate, air flow split and the duration of increased air flow are calculated based on one of: the effective runtime anode leak rate or the shutdown leak rate.

According to another aspect, when initiating adaptations of the control strategy of the fuel cell based on one of the effective runtime anode leak rate or the shutdown leak rate, the controller is further adapted to, during run-time operation of the fuel cell, at least one of reduce bleed frequency, increase airflow through the cathode to compensate for the oxygen consumed by hydrogen gas that permeates through the electrolyte membrane, and limit transient load rates to control emissions during and after power load fluctuations.

According to another aspect, when initiating adaptations of the control strategy of the fuel cell based on one of the effective runtime anode leak rate or the shutdown leak rate, the controller is further adapted to, during a shutdown operation of the fuel cell, vent hydrogen gas from the anode and the cathode directly to exhaust, and reduce the anode and cathode pressure.

According to another aspect, when initiating adaptations of the control strategy of the fuel cell based on one of: the effective runtime anode leak rate or the shutdown leak rate, the controller is further adapted to, during a freeze start operation of the fuel cell, reduce bias pressure between the anode and the cathode, and, during extended period of non-use of the fuel cell, continuously, on a periodic basis, monitor pressure decay within the anode, and initialize H2-in-park measures to ensure that sufficient hydrogen gas remains present within the anode for a start-up operation when pressure decay within the anode indicates that oxygen has leaked into the anode.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having a fuel cell propulsion system including a fuel cell according to an exemplary embodiment of the present disclosure;

FIG. 2 is a schematic side view of a fuel cell according to an exemplary embodiment;

FIG. 3 is a schematic block diagram of the fuel cell shown in FIG. 2;

FIG. 4A is a schematic side view of the fuel cell shown in FIG. 2, illustrating how hydrogen migrates from the anode to the cathode through permeations within the electrolyte membrane;

FIG. 4B is the schematic side view of the fuel cell shown in FIG. 4A, wherein the air flow device is increasing the flow of air through the cathode;

FIG. 4C is the schematic side view of the fuel cell shown in FIG. 4A, wherein the air flow device is increasing the flow of air through both the cathode and through a cathode bypass valve;

FIG. 4D is the schematic side view of the fuel cell shown in FIG. 4A, wherein the cathode bypass valve is closed, and the air flow device maintains increased airflow through the cathode to push remaining hydrogen from the cathode;

FIG. 5 is the schematic side view of the fuel cell shown in FIG. 4A, wherein, during a shutdown operation, an isolation valve open allowing hydrogen gas to vent from the anode, through an anode purge valve, through the cathode to a tailpipe or vent directly to the tailpipe of the vehicle;

FIG. 6 is a schematic flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, stationary applications, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

In addition, disclosure of ranges includes disclosure of all values and further divided ranges within the entire range, including endpoints and sub-ranges given for the ranges.

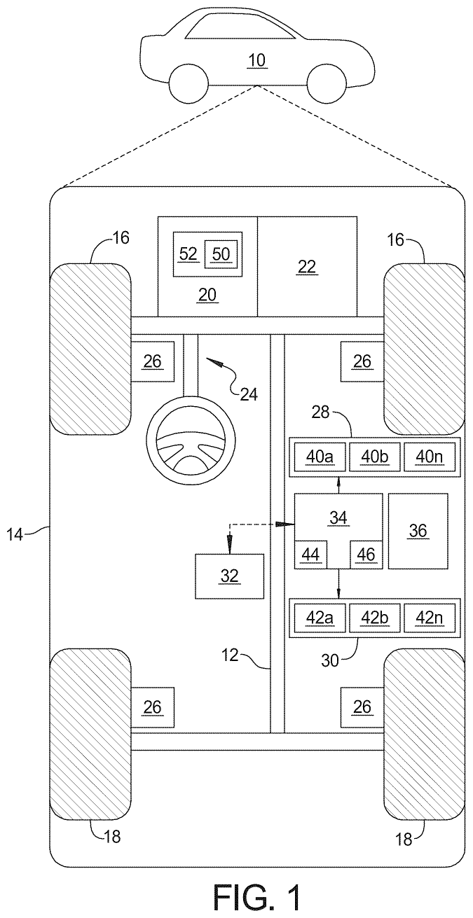

Example embodiments will now be described more fully with reference to the accompanying drawings. In accordance with an exemplary embodiment, FIG. 1 shows a vehicle 10 with an associated fuel cell 50. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a fuel cell propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, powered by the fuel cell 50, or a stack including multiple fuel cells 50, there may be no transmission system 22. The transmission system 22 is configured to transmit power from the fuel cell propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of sensing devices 40a-40n further includes sensors to determine information about the environment surrounding the vehicle 10, for example, an ambient air temperature sensor, a barometric pressure sensor, and/or a photo and/or video camera which is positioned to view the environment in front of the vehicle 10. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

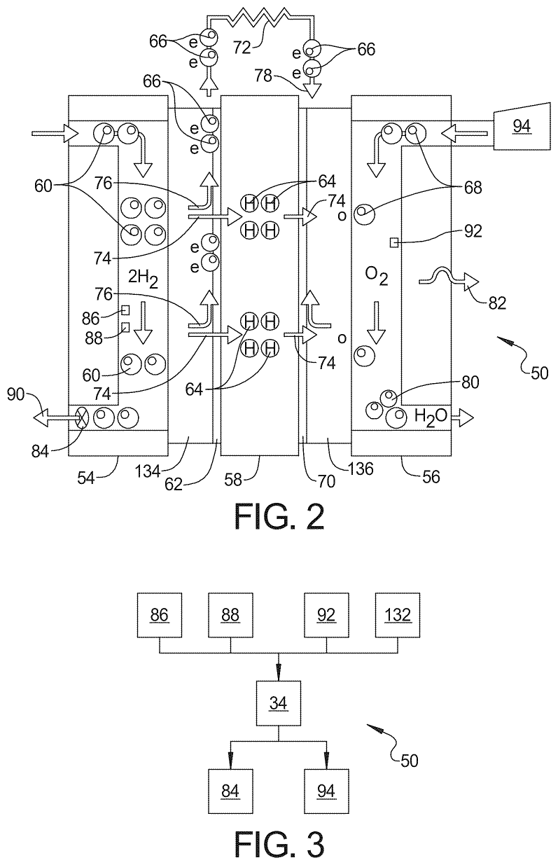

Referring to FIG. 2, the fuel cell propulsion system 20 includes a stack 52 including a plurality of fuel cells 50. In an exemplary embodiment, each fuel cell 50 is a hydrogen fuel cell that is an electro-chemical device in which a free energy change resulting from an oxidation reaction is converted into electrical energy. A fuel cell 50 includes an anode 54 (fuel electrode) and a cathode 56 (oxidant electrode), separated by an ion-conducting electrolyte 58 positioned therebetween. A fuel 60 (typically hydrogen, H₂) capable of chemical oxidation is supplied to the anode 54 and ionizes on a suitable catalyst 62 to produce hydrogen protons (H⁺) 64 and electrons 66. Gaseous hydrogen 60 has high reactivity in the presence of a suitable catalyst 62 and high energy density. Similarly, an oxidant 68 (typically air, O₂) is supplied to the fuel cell cathode 56 and reacts with a suitable catalyst 70 at the cathode 56. Gaseous oxygen 68 is readily and economically available from the air for fuel cells. The anode 54 receives hydrogen gas 60 and the cathode 56 receives oxygen 68 or air.

The hydrogen gas 60 is dissociated in the anode 54 to generate free hydrogen protons 64 and electrons 66. The anode 54 and cathode 56 are connected electrically to a load 72 (such as an electronic circuit) by an external circuit conductor. The hydrogen protons 64 pass through the electrolyte 58 to the cathode 56, as indicated by arrow 74. The electrons 66 from the anode 54 cannot pass through the electrolyte 58, and thus are directed through the load 72, as indicated by arrow 76, to perform work before being sent to the cathode 56, as indicated by arrow 78. Proton exchange membrane fuel cells (PEMFC) are a popular fuel cell type for vehicles, and generally includes a solid polymer electrolyte proton conducting membrane for an electrolyte 58, such as a perfluorosulfonic acid membrane. The catalysts 62, 70 of the anode 54 and cathode 56 typically include finely divided catalytic particles, usually platinum (Pt), supported on carbon particles and mixed with an ionomer, where the catalytic mixture is deposited on opposing sides of the electrolyte membrane 58. The combination of the anode catalytic mixture (anode catalyst 62), the cathode catalytic mixture (cathode catalyst 70), gas diffusion layers 134, 136, and the membrane (electrolyte 58) define a membrane electrode assembly (MEA). The membranes block the transport of gases between the anode side 54 and the cathode side 56 of the fuel cell 50 while allowing the transport of protons 64 to complete the anodic and cathodic reactions on their respective electrodes 54, 56. At the cathode 56, oxygen gas 68 reacts with the hydrogen protons 64 migrating through the electrolyte 58 and the incoming electrons 66 from the external circuit to produce water 80 as a byproduct. The byproduct water 80 is typically extracted as vapor. The overall reaction that takes place in the fuel cell 50 is the sum of the anode 54 and cathode 56 reactions, with part of the free energy of reaction released directly as electrical energy (used by the load 72). The difference between this available free energy and the heat of reaction is produced as heat, as indicated by arrow 82.

In an exemplary embodiment, several fuel cells 50 are combined in a fuel cell stack 52 to generate the desired power. A fuel cell stack 52 typically includes a series of flow field or bipolar plates positioned between the several MEAs in the stack 52, where the bipolar plates and the MEAs are positioned between two end plates. The bipolar plates include an anode side and a cathode side for adjacent fuel cells 50 in the stack 52. Anode gas flow channels are provided on the anode side of the bipolar plates that allow the anode reactant gas 60 to flow to the respective MEA. Cathode gas flow channels are provided on the cathode side of the bipolar plates that allow the cathode reactant gas 68 to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack 52. The bipolar plates also include flow channels through which a cooling fluid flows. The fuel (hydrogen) 60 and oxidant (air) 68 are introduced through manifolds to their respective side 54, 56. In some applications the fuel 60 and oxidant 68 supply streams are designed as flow-through systems, however, these systems add a parasitic load to the fuel cell 50 output and thus reduce the net power that can be extracted. In other configurations the fuel stream or the oxidant stream or both are “dead-ended”. This dead-ended operation creates issues such as water removal and accumulation of impurities. Thus, in an exemplary embodiment of the present disclosure, the flow-through capability of fuel 60 into and through the anode side 54 of the fuel cell 50 is controlled with an anode valve 84 or anode valves, allowing selective flow of reacted fuel gas 90 from the anode 54 to the atmosphere surrounding the fuel cell 50.

The MEAs in the fuel cells 50 are permeable and thus allow nitrogen in the air from the cathode side 56 of the stack to permeate through and collect in the anode side 54 of the stack 52, often referred to as nitrogen cross-over. Even though the anode side 54 pressure may be slightly higher than the cathode side 56 pressure, cathode side 56 partial pressures will cause air to permeate through the electrolyte membrane 58. Nitrogen in the anode side 54 of the fuel cell 50 dilutes the hydrogen 60 such that if the nitrogen concentration increases above a certain percentage, such as 50%, fuel cells 50 in the stack 52 may become starved of hydrogen 60. If a fuel cell 50 becomes hydrogen starved, the fuel cell stack 52 will fail to produce adequate electrical power and may suffer damage to the catalyst 62 in anode 54 and catalyst 70 in cathode 56 in the fuel cell stack 52. Further, under heavy load, evaporation of water 80 by-product at the cathode 56 takes place slower than formation, and water 80 tends to migrate back through the polymer electrolyte 58 to the anode side 54. Some spots on a fuel cell 50 are cooler than others, and the moisture condenses at these locations into liquid water 80, flooding the anode 54 and impeding the reaction at the anode 54. Additionally, other impurities accumulate at the anode 54, and may poison the anode reaction sites. Inert contaminants also result in loss of performance by lowering the fuel partial pressure. Thus, it is known in the art to provide an anode valve 84 in the anode exhaust gas output line of the fuel cell stack 52 to remove nitrogen and water 80 from the anode side 54 of the stack 52. This allows controlled venting of a proportion (perhaps from 0.1 to 10%) of gaseous fuel(reacted fuel gas) through a throttled opening, removing accumulated impurities, water 80 and fine particulates from the anode side 54 and restoring fuel cell 50 performance. For purposes of clarity and to avoid confusion, accumulated gases that are being vented are referred to herein as “reacted fuel gas”. It should be understood to those skilled in the art that reacted fuel gas is mainly hydrogen 60 with trace amounts of water 80 and possibly nitrogen, carbon dioxide and carbon monoxide. Depending on the construction of the fuel cell 50, other gases might also be found in reacted fuel gas.

A fuel cell propulsion system controller includes control algorithms that identify a desirable minimum hydrogen gas 60 concentration in the anode 54, and cause the anode valve 84 to open when the gas concentration falls below that threshold, controlling the length of, and intervals between, successive purges, and monitoring the fuel cell power output to provide for the exhaust to be approximately proportional to the amount of hydrogen 60 consumed by the fuel cell 50. The fuel cell propulsion system controller may be the vehicle controller 34, or a separate controller, in communication with the vehicle controller 34 and dedicated to controlling the fuel cell propulsion system 20. However, release of hydrogen 60 into the open air may create a safety hazard if the concentration of hydrogen 60 is above a target value. Increasing the flow of air 68 into the cathode side 56 of the fuel cell 50, dilutes the hydrogen 60 present in the purged gas, so when the purged gas reaches the atmosphere surrounding the fuel cell 50, the concentration of hydrogen in tailpipe 101 is low enough to be safely vented into the atmosphere.

It is known in the art to estimate the molar fraction of gases in the anode side 54 of a fuel cell stack 52 using a sensor or model to determine when to perform the bleed of the anode side 54 or anode sub-system. For example, gas concentration estimation (GCE) models are known for estimating hydrogen, nitrogen, oxygen, water vapor, etc. in various volumes of a fuel cell system, such as the anode flow-field, anode plumbing, cathode flow-field, cathode header and plumbing, etc. Thus, the controller 34 can determine when to initiate opening of the anode valve 84 for a purge.

Further, it is known in the art to monitor and measure gas leaks from the anode 54 within a fuel cell 50. Gas leaks from the anode 54 sub-system in a fuel cell 50 are a major concern because the hydrogen gas species present in the mixture may impact overall system efficiency and product safety. For example, there could be significant safety concerns resulting from bipolar plate and/or seal ruptures that can be catastrophic to an otherwise repairable fuel cell stack and possibly create a dangerous environment for the vehicle operator. Further, because of emissions requirements, hydrogen gas leak detection must be accurate to ensure compliance and enable reactive actions when gas is lost from the anode 54.

Known methods exist to determine the total amount of molecular gas in the anode 54 volume of the fuel cell stack 52 at a start of a leak detection time period during the leak detection condition. Such methods also determine a crossover loss of the hydrogen gas 60 from the anode 54 volume of the fuel cell stack 52 during the leak detection time period as a result of permeation through membranes (electrolyte membrane 58) in the fuel cell stack 52, determine an overboard loss of the hydrogen gas 60 from the anode 54 volume of the fuel cell stack 52 during the leak detection time period as a result of permeation through other components, such as gaskets, valves and seals, in the fuel cell stack 52, and determine a reaction loss of the hydrogen gas 60 from the anode 54 volume of the fuel cell stack 52 during the leak detection time period as a result of an electro-chemical reaction in the stack 52. These methods also determine the total amount of molecular gas in the anode 54 volume of the fuel cell stack 52 at the end of the leak detection time period and subtract it from the hydrogen gas 60 present in the anode 54 volume at the start of the leak detection condition giving the total gas loss. The crossover, overboard and reaction losses are added to get an added loss, which is subtracted from the total gas loss to get a leak loss from the anode 54 volume. This anode leak loss is compared to a pre-determined threshold to determine whether a significant enough gas leak is present to trigger end-of-life for the fuel cell 50.

Further details of measuring the anode 54 shutdown leak rate of a fuel cell 50 are included in U.S. Pat. No. 8,524,405 to Salvador et al., issued on Sep. 3, 2013 and U.S. Pat. No. 11,043,682 to Gagliardo et al., issued Jun. 22, 2021, both of which are assigned to GM Global Technology Operations LLC and are hereby incorporated by reference into the present application.

In an exemplary embodiment of the present disclosure, the controller 34 of the fuel cell 50 is adapted to measure an anode leak rate for the fuel cell 50 and update the measured anode leak rate whenever power output of the fuel cell 50 is zero either by measuring an anode shutdown leak rate for the fuel cell by known methods, such as described above, or, by monitoring pressure decay within the anode 54 during low-power operation of the fuel cell 50, and estimating the anode leak rate based on the pressure decay observed within the anode 54 during low-power operation of the fuel cell 50. The measured anode leak rate may be updated anytime the fuel cell 50 is operating at zero power draw. Anytime there is a current present within the fuel cell 50, there is error in leak testing, thus, updating the measured anode leak rate takes place when there is zero power draw on the fuel cell 50, such as when the vehicle 10 is stopped in traffic. The estimated leak rate taken during low power is used as a substitution for the leak rate when power output of the fuel cell 50 is zero (shutdown leak rate) for the effective leak orifice size calculation in situations where the shutdown leak rate cannot be successfully conducted or cannot be conducted regularly due to the extended long operating hours. Cathode pressure also has effects on the anode pressure changing rate. This becomes more significant when the fuel cell membrane becomes degraded. Therefore, patented anode shutdown leak rate measurement method can be updated to consider both anode pressure changing and cathode pressure changing when conducting the anode leak rate measurement.

The controller 34 is then adapted to model, using the measured anode leak rate, an effective electrolyte membrane orifice size. Thus, the controller 34 uses the measured anode leak rate to model an orifice size within the electrolyte membrane 58 that would correspond to the measured anode leak rate. With the modelled electrolyte membrane orifice size, the controller 34 can calculate an effective anode leak rate at any operating condition of the fuel cell 50. Then, the controller 34 calculates, using the effective electrolyte membrane orifice size, an effective runtime anode leak rate during operation of the fuel cell.

As discussed above, increasing the flow of air 68 into the cathode side 56 or bypass valve 110 of the fuel cell 50, dilutes the hydrogen 60 present in the purged gas (reacted fuel gas 90), so when the purged gas reaches the atmosphere surrounding the fuel cell 50, the concentration of hydrogen 60 is low enough to be safely vented into the atmosphere. Once the controller 34 calculates the effective runtime anode leak rate, the controller 34 will use the effective runtime anode leak rate as a low-side metric when calculating emissions and dilution requests. Thus, regardless of other operating conditions, the controller 34 uses the calculated effective runtime anode leak rate as a baseline, and calculates emission levels and dilution requests based on presumptive hydrogen gas 60 levels according to the calculated effective runtime anode leak rate.

Further, the controller 34 is adapted to initiate adaptations of a control strategy of the fuel cell 50 based on the effective runtime anode leak rate or shutdown leak rate directly. Such adaptations include modifying operating parameters of the fuel cell 50 to compensate for the leakage. Thus, as the electrolyte membrane 58 degrades over time, the controller 34 will calculate and continuously update, an effective anode leak rate, and, rather than trigger end-of-life of the fuel cell 50, will initiate adaptations of the control strategy for the fuel cell 50, modifying operating parameters to take into account and compensate for anode leakage across the electrolyte membrane 58 and allowing continued safe operation of the fuel cell 50 beyond anode leak rates that would traditionally trigger end-of-life.

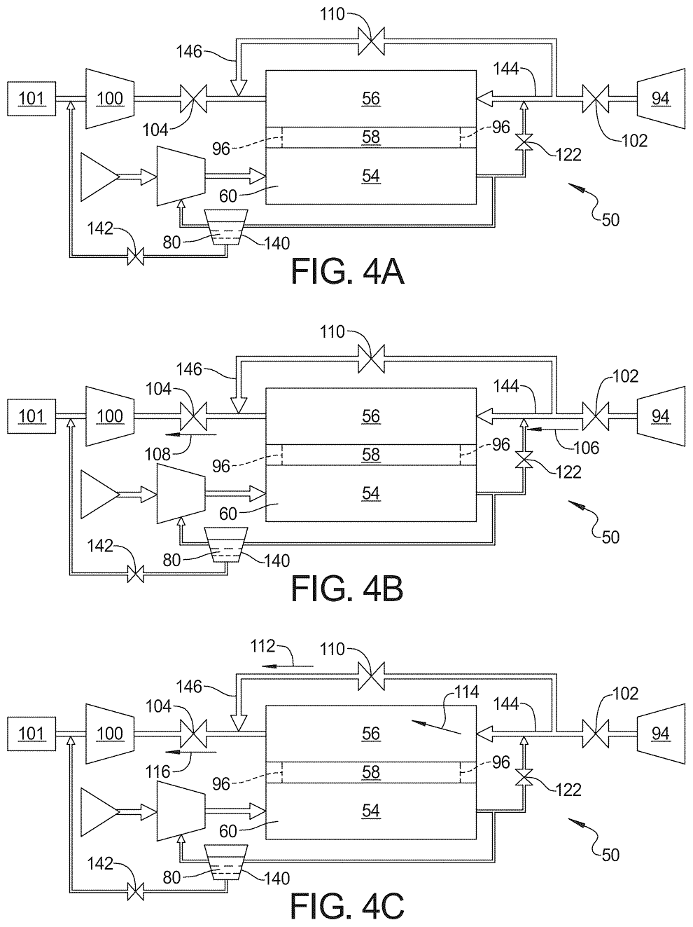

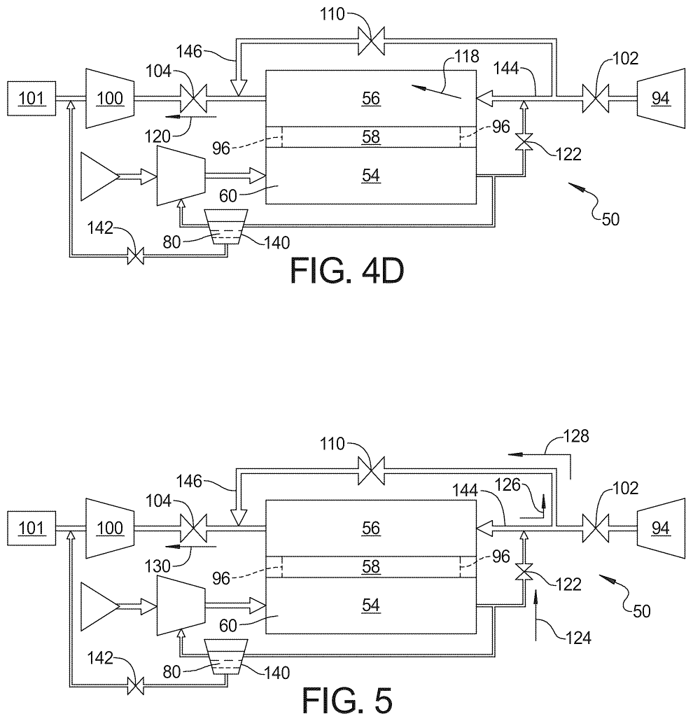

Referring again to FIG. 2, FIG. 3 and to FIG. 4A, in an exemplary embodiment of the present disclosure, the controller 34 is adapted to monitor, with a first sensor or model 86 in communication with the controller 34, a concentration of hydrogen gas 60 present at the anode 54 of the fuel cell 50, monitor, with a second sensor or model 88 in communication with the controller 34, an accumulated liquid of water 80 present at the anode 54 of the fuel cell 50 (captured within a liquid accumulator 140), and, initiate a selective purge of reacted fuel gas 90 (via opening of an anode purge valve 122) when the concentration of hydrogen gas 60 present at the anode 54 is less than a predetermined concentration, or a drain of liquid water 80 from the anode 54 of the fuel cell 50 when the amount of accumulated liquid water 80 present at the anode 54 (within the liquid accumulator 140) is more than a predetermined threshold value by opening a water drain valve 142, allowing liquid water 80 to drain from the liquid accumulator 140 to the cathode inlet 144 or tailpipe 101.

The system controller 34, using the first sensor or model 86, can detect when the concentration of hydrogen gas 60 within the anode falls due to the presence of too much nitrogen, or other impurities within the reacted fuel gas 90, thus prompting the controller 34 to initiate a selective purge of the reacted fuel gas 90 from the anode 54. This lowers pressure within the anode 54 and allows pure H2 fuel 60 to enter the anode 54 from the injector, thus increasing the amount of hydrogen 60 within the anode 54. Likewise, the system controller 34, using the second sensor or model 88, can detect when the amount of accumulated liquid water 80 within the anode 54 builds to a level impeding the catalytic reaction of hydrogen gas 60 within the anode 54, thus prompting the controller 34 to initiate a selective drain of liquid water from the anode 54 through the water drain valve 142.

Once the controller 34 initiates a selective purge or drain of the anode 54, the controller 34 monitors, with a third sensor or model 92, a flow rate of air 68 into the fuel cell 50, and estimates a required flow rate of air 68 into the fuel cell 50 necessary to dilute the concentration of hydrogen 60 present within the tailpipe 101 below a predetermined level. As discussed above, a safe concentration of hydrogen 60 in vented reacted fuel gas 90 (tailpipe 101) is less than a target level. The controller 34 purges the anode 54 high concentration H2 (for example, 75%) into the cathode inlet 144 or tailpipe 101. At the same time, high air flow is pushed through the cathode 56 or bypass valve 110 to the exhaust (tailpipe 101) as well. By providing enough extra air, the H2 concentration in exhaust at the tailpipe 101 will be below a target level. There are two options. The first option is to purge to cathode inlet, the second option is to purge to exhaust. The benefit of the first option is that high concentration H2 will be mixed with air in the cathode 56 and react with each other to generate water directly. Therefore, the amount of H2 entering the exhaust at the tailpipe 101 will be largely reduced.

The controller 34, increases the flow rate of air 68 into the fuel cell 50 by actuating an air flow device 94 adapted to push air 68 into the fuel cell 50. The air flow from the air flow device 94 may push air through the isolation valve 102 into the cathode 56, or, alternatively, the air flow from the air flow device 94 may push air through the cathode bypass valve 110 to the exhaust (tailpipe 101) directly. The air flow device 94 may be a blower, turbine or compressor that is adapted to pull ambient external air and push the air 68 into the fuel cell 50. The controller 34 increases the force that the air flow device pushes air 68, thus, increasing the volume of air 68 that is pushed through the fuel cell. During normal operating conditions, the air flow device 94 is adapted to deliver air 68 into the fuel cell 50 at a normal operating flow rate. When initiating a purge of the reacted fuel gas 90 or a drain of liquid water, the controller 34 actuates the air flow device 94 to increase the flow rate of air 68 entering the fuel cell 50 from the normal operating flow rate to the estimated required flow rate to dilute the concentration of hydrogen 60 present within the reacted fuel gas 90 at the tailpipe 101 to a target level.

In an exemplary embodiment, the controller 34 is adapted to initiate adaptations of the control strategy of the fuel cell 50 based on the effective runtime anode leak rate or shutdown leak rate that include, during start-up of the fuel cell 50, increasing a duration of increased air flow through the cathode bypass valve 110 of the fuel cell 50 to dilute the concentration of hydrogen gas 60 leaked from the anode 54. Here, anode 54 to cathode 56 bias pressure, air flow rate, air flow split and the duration of increased air flow are calculated based on the effective runtime anode leak rate.

Referring again to FIG. 4A, when the fuel cell is off, hydrogen gas 60 can accumulate within the cathode 56 through permeation 96 within the electrolyte membrane 58, as indicated by arrow 98. Emission levels within a tailpipe 101 of the vehicle 10 downstream of the fuel cell 50 are acceptable due to a closed state of an isolation valve 102 positioned between the air flow device 94 and the cathode 56, and a closed state of a back-pressure valve 104 positioned between the cathode 56 and the tailpipe 100. The isolation valve 102 and the back-pressure valve 104 keep hydrogen gas 60, that leaks across the electrolyte membrane 58 from the anode 54 into the cathode 56, within the cathode 56.

Referring to FIG. 4B, at the beginning of start-up of the fuel cell 50, the isolation valve 102 is kept closed until air flow through the air flow device 94 increases to a predetermined level. Thus, when the isolation valve 102 is opened, the air flow is sufficient to prevent back flow of hydrogen gas 60 from the cathode 56, and the air flow from the air flow device 94, as indicated by arrow 106, begins to push hydrogen gas 60 within the cathode 56 out through the back-pressure valve 104, as indicated by arrow 108, reducing the level of hydrogen gas 60 within the cathode 56.

Referring to FIG. 4C, increased air flow continues through both a cathode bypass valve 110, that bypasses the cathode 56, as indicated by arrow 112, and through the cathode 56 itself, as indicated by arrow 114, wherein hydrogen gas 60 is purged from the fuel cell 50, as indicated by arrow 116, and, finally, referring to FIG. 4D, after the major amount of H2 is purged out of cathode 56, the cathode bypass valve 110 could be closed, and increased air flow is continued only directly through the cathode 56, as indicated by arrow 118, to push the remaining hydrogen gas 60 out of the cathode 56, as indicated by arrow 120.

In another exemplary embodiment, the controller 34 is adapted to initiate adaptations of the control strategy of the fuel cell 50 based on the effective runtime anode leak rate or shutdown leak rate that include, during run-time operation of the fuel cell 50, initiating a bleed function to vent hydrogen gas 60 from the anode 54 of the fuel cell 50. During run-time operation of the fuel cell 50, pressures within the anode 54 are higher than pressures within the cathode 56, thus, promoting permeation of hydrogen gas 60 through the electrolyte membrane 58. This condition is further amplified by degradation over time of the electrolyte membrane 58, allowing increased rates of permeation through the electrolyte membrane 58. Initiating a bleed function, via the anode purge valve 122, to vent hydrogen gas 60 from the anode 54 increases the concentration of hydrogen gas 60 therein. Such a bleed may be accomplished by the continuous purge through the degraded membrane 58, as described above, wherein the level of hydrogen gas 60could be increased due to the continuous purge through the degraded membrane 58.

In another exemplary embodiment, the controller 34 is adapted to initiate adaptations of the control strategy of the fuel cell 50 based on the effective runtime anode leak rate or shutdown leak rate that include, during run-time operation of the fuel cell 50, increase airflow through the cathode 56 to compensate for the oxygen 68 consumed by hydrogen gas 60 that permeates through the electrolyte membrane 58. As discussed above, the controller 34 actuates the air flow device 94 to increase the flow of air forced into the cathode 56, increasing the level of oxygen 68 therein. Leakage of hydrogen gas 60 from the anode 54 to the cathode 56 through a degraded electrolyte membrane 58 displaces air 68 within the cathode 56, reducing the amount of oxygen 68 available to react with hydrogen protons 64 and free electrons 66. By increasing the air flow, oxygen 68 is more rapidly fed into the cathode 56 providing an increased supply of oxygen 68, and avoiding potential loss of voltage produced by the fuel cell 50.

In another exemplary embodiment, the controller 34 is adapted to initiate adaptations of the control strategy of the fuel cell 50 based on the effective runtime anode leak rate or shutdown leak rate that include, during run-time operation of the fuel cell 50, limiting transient load rates to control emissions within the fuel cell 50. High leakage across the electrolyte membrane 58 will allow pure hydrogen gas 60, that has not been broken down into hydrogen protons 64, to leak across from the anode 54 to the cathode 56. During up transient (power increases quickly), the H2 leaking through the highly degraded membrane 58 to cathode 56 may be pushed quickly into exhaust and cathode air flow may not be increased fast enough to dilute the level of H2 therein. During down transient (power reduce dramatically), the air flow may reduce too fast with the reduction of current. Thus, a large amount of H2 could go into exhaust without sufficient dilution as well. As discussed above, with less than sufficient air available, the emission of fuel cell 50 may become a problem. To compensate for this, the controller 34 limits the load change rate that may be placed on the fuel cell 50, thus only allowing a load change rate that can be accommodated by the fuel cell 50 and avoiding a potential emission issue. This situation may force operation of the vehicle 10 at reduced performance levels, which may or may not be acceptable to a driver/passenger of the vehicle 10. Thus, an owner of the vehicle 10, upon occurrence of such limitations and reduced performance of the vehicle 10 may elect to accept the reduced performance of the vehicle 10 and continue operating the vehicle 10, extending the life of the fuel cell 50, or, alternatively, the owner may not accept such reduced performance of the vehicle 10, and may elect to consider such condition as an end-of-life event for the fuel cell 50. This way, an owner/operator of a vehicle can elect to prolong the life of the fuel cell 50, at the cost of reduced performance, or, may elect to replace/repair the fuel cell 50 immediately.

In another exemplary embodiment, the controller 34 is adapted to initiate adaptations of the control strategy of the fuel cell 50 based on the effective runtime anode leak rate or shutdown leak rate that include, during a shutdown operation of the fuel cell 50, venting hydrogen gas 60 from the anode 54 and the cathode 56 directly to exhaust (tailpipe 101), and reducing the anode 54 and cathode 56 pressure. During shutdown, the pressure within the anode 54 must be higher than the pressure within the cathode 56 to enable the system to measure/test the anode 54 shutdown leak rate. Shutdown leak detection occurs as the last step in a fuel cell shutdown operation. During this time, hydrogen gas 60 that is not being consumed while the fuel cell 50 shuts down gets pushed from the anode 54 to the cathode 56 due to the bias pressure of the anode 54 over the cathode 56 and can build up within the cathode 56.

Referring to FIG. 5, during the shutdown operation, hydrogen gas 60 from the anode 54 is vented to cathode inlet 144 and then to exhaust (tailpipe 101) via the anode purge valve 122, as indicated by arrow 124, and the cathode back pressure valve 104, or vented directly to exhaust. Simultaneously, hydrogen gas 60 from the cathode 56 is vented directly to exhaust via opening of the back-pressure valve 104, as indicated by arrow 130. Thus, immediately following shutdown leak testing of the anode 54, at the end of the shutdown operation of the fuel cell 50, the anode purge valve 122, the anode drain valve 142, the cathode bypass valve 110 and the back-pressure valve 104 could all be opened to allow excess hydrogen gas 60 within the fuel cell 50 to vent to exhaust at the tailpipe 101, lowering the pressure differential between the anode 54 and the cathode 56 and reducing the amount of hydrogen gas 60 that will continue to permeate through the electrolyte membrane 58 from the anode 54 to the cathode 56 during off-time.

In another exemplary embodiment, the controller 34 is adapted to initiate adaptations of the control strategy of the fuel cell 50 based on the effective runtime anode leak rate or shutdown leak rate that include, during a freeze start operation of the fuel cell 50, reducing bias pressure between the anode 54 and the cathode 56. During freeze start-up of the fuel cell 50, high bias pressure between the anode 54 and the cathode 56 is normally desired to let anode 54 and cathode 56 reach nitrogen partial pressure equilibrium to stop N2 permeating without overly affecting anode hydrogen concentration, therefore, no purge request will be needed considering ice could block gas flow. However, constant leakage through a degraded electrolyte membrane 58 makes the high bias pressure un-necessary, enabling a strategy modification including dumping hydrogen gas 60 from the anode 54 to the cathode 56 then to exhaust through the degraded membrane 58.

A freeze start is when the fuel cell 50 is activated when a temperature, as measured by a fourth sensor or model 132 within the fuel cell 50 is below a predetermined level, such as freezing (0 degrees Celsius). Components of a fuel cell include the electrolyte membrane 58, catalyst layers 62, 70, gas diffusion layers 134, 136, micro-porous layer and bipolar plate. Hydrogen and air flows pass through the anode 54 and cathode 56 flow channels, respectively. Diffusion and convection of the gases co-exist in the porous layers. The catalyst layers 62, 70 are comprised of a mixture of catalyst particles, ionomer, and porous carbon backbone. Electrochemical reactions occur on the three-phase coexistence sites (ionomer, gas, and catalyst) in the catalyst layers 62, 70. Electricity is generated during operation, along with water as the reaction product. During a cold start, water transforms from one phase or state to another. It can be absorbed by the ionomer and become membrane water. Part of the membrane water can transform to frozen membrane water due to subfreezing temperatures. Water can also evaporate from the ionomer. The resulting vapor percolates through the porous layers and enters into the flow channel. Water vapor can also deposit and accumulate in the porous layers as ice. Lastly, water can stay in a supercooled liquid state under certain conditions. During a cold start, temperature rises due to the exothermic electrochemical reaction. A successful cold start requires that the catalyst layers 62, 70 temperature exceeds the ice's melting point before the reaction sites and diffusion pathways are blocked. In this case, ice melts and liquid water can be drained, thus, the stoichiometry within the cathode is low to generate enough heat until the fuel cell warms up.

In another exemplary embodiment, the controller 34 is adapted to initiate adaptations of the control strategy of the fuel cell 50 based on the effective runtime anode leak rate or shutdown leak rate that include, during a stand-by operation, such as when the vehicle 10 is idle at a traffic light or during a traffic jam, of the fuel cell 50, continuously, on a periodic basis, monitoring pressure decay within the anode 54, and updating the shutdown leak rate when power output is zero.

During an extended period of non-use, H2-in-park measures are used to ensure that sufficient hydrogen gas 60 remains present within the anode 54 for a start-up operation when pressure decay within the anode 54 indicates that oxygen 68 has leaked into the anode 54. H2-in-park measures include methods known in the industry adapted to ensure that hydrogen gas 60 is not completely eliminated from the anode 54 and cathode 56 during an off period, thus ensuring that when the fuel cell 50 is once again actuated and begins a start-up operation, there is no oxygen within the anode 54 for efficient start-up without damage to the electrodes of the fuel cell 50. When the pressure within both the anode 54 and the cathode 56 are higher than ambient air pressure, H2-in-park measures may be un-necessary. However, if the pressure within either the anode 54 or the cathode 56 is less than the ambient air pressure, then air may leak into the fuel cell 50. If pressure decay within the anode 54 indicates that oxygen leakage into the fuel cell 50 has occurred, the controller 34 can initialize H2-in-park measures to compensate for such leakage.

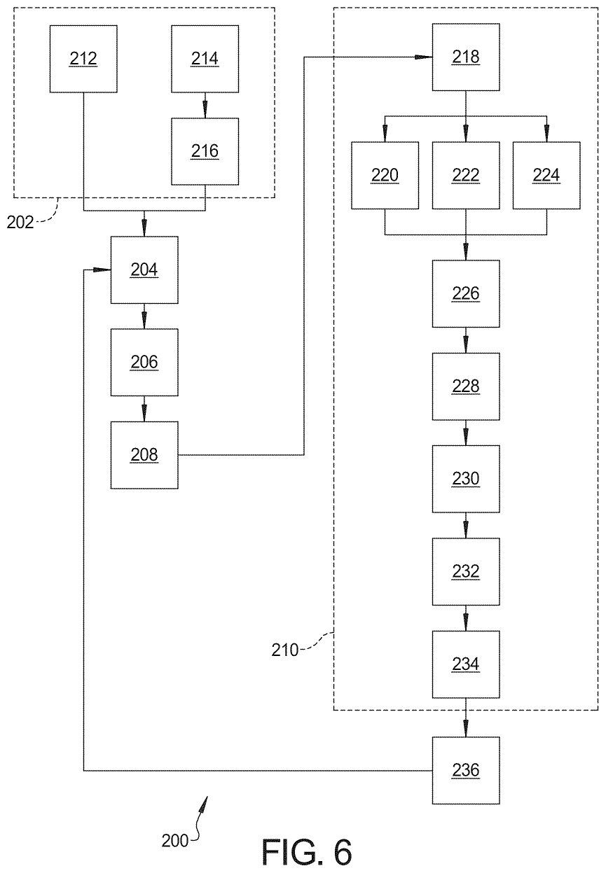

Referring to FIG. 6, a method 200 of controlling a hydrogen fuel cell 50 includes, with a controller 34 of the fuel cell, beginning at block 202, measuring an anode leak rate for the fuel cell 50, moving to block 204, modelling, using the measured anode leak rate, an effective electrolyte membrane orifice size, moving to block 206, calculating, using the effective electrolyte membrane orifice size, an effective runtime anode leak rate during operation of the fuel cell 50, moving to block 208, using the effective runtime anode leak rate as a low-side metric when calculating emissions and dilution requests, and, moving to block 210, initiating adaptations of a control strategy of the fuel cell 50 based on one of: the effective runtime anode leak rate or a shutdown leak rate.

In an exemplary embodiment, the measuring an anode leak rate for the fuel cell 50 at block 202 further includes, moving to block 212, measuring an anode shutdown leak rate for the fuel cell 50. In another exemplary embodiment, the measuring an anode leak rate for the fuel cell 50 at block 202 further includes, moving to block 214, monitoring pressure decay within the anode 54 during low-power operation of the fuel cell 50, and, moving to block 216, estimating the anode leak rate based on the pressure decay within the anode 54 during low-power operation of the fuel cell 50.

In another exemplary embodiment, the initiating adaptations of the control strategy of the fuel cell 50 based on one of: the effective runtime anode leak rate or a shutdown leak rate at block 210 further includes, moving to block 218, during start-up of the fuel cell 50, increasing a duration of increased air flow through a cathode 56 of the fuel cell 50 (could go through cathode or cathode bypass valve) to dilute the concentration of hydrogen 60 leaked from the anode 54, wherein, anode 54 to cathode 56 bias pressure, air flow rate, air flow split and the duration of increased air flow are calculated based on the effective runtime anode leak rate.

In another exemplary embodiment, the initiating adaptations of the control strategy of the fuel cell 50 based on the effective runtime anode leak rate or shutdown leak rate at block 210 further includes, moving to block 220, adapting, during run-time operation of the fuel cell 50, a bleed function request frequency to vent hydrogen gas 60 from the anode 54 of the fuel cell 50.

In another exemplary embodiment, the initiating adaptations of the control strategy of the fuel cell 50 based on the effective runtime anode leak rate or shutdown leak rate at block 210 further includes, moving to block 222, increasing, during run-time operation of the fuel cell 50, airflow through the cathode 56 to compensate for the oxygen 68 consumed by hydrogen gas 60 that permeates through the electrolyte membrane 58.

In another exemplary embodiment, the initiating adaptations of the control strategy of the fuel cell 50 based on the effective runtime anode leak rate or shutdown leak rate at block 210 further includes, moving to block 224, limiting, during run-time operation of the fuel cell 50, transient load rates to control emissions within the fuel cell 50 during and after power load fluctuations.

In another exemplary embodiment, the initiating adaptations of the control strategy of the fuel cell 50 based on the effective runtime anode leak rate or shutdown leak rate at block 210 further includes, during a shutdown operation of the fuel cell 50, moving to block 226, venting hydrogen gas 60 from the anode 54 and the cathode 56 directly to exhaust at the tailpipe 101, and, moving to block 228, reducing bias pressure between the anode 54 and the cathode 56.

In another exemplary embodiment, the initiating adaptations of the control strategy of the fuel cell 50 based on the effective runtime anode leak rate or shutdown leak rate at block 210 further includes, during a freeze start operation of the fuel cell 50, moving to block 230, reducing bias pressure between the anode 54 and the cathode 56.

In another exemplary embodiment, the initiating adaptations of the control strategy of the fuel cell 50 based on the effective runtime anode leak rate or shutdown leak rate at block 210 further includes, during a stand-by operation of the fuel cell 50, moving to block 232, continuously, on a periodic basis, monitoring pressure decay within the anode 54 when the power output is zero, and, during an extended period of non-use, moving to block 234, initializing H2-in-park measures to ensure that sufficient hydrogen gas 60 remains present within the anode 54 for a start-up operation when pressure decay within the anode 54 indicates that oxygen 68 has leaked into the anode 54.

In still another exemplary embodiment, the method 200 further includes, moving to block 238, updating the measured anode leak rate whenever power output of the fuel cell 50 is zero, wherein the method reverts back to block 204 and proceeds using the updated measured anode leak rate.

A fuel cell 50, fuel cell propulsion system 20 and method 200 of the present disclosure offers several advantages. These include determining how much air flow is required to dilute exiting reacted fuel gas 90 within the anode 54 such that concentration of hydrogen gas 60 therein is low enough to be safely vented to atmosphere, and using an effective anode shutdown leak or low power run-time leak rate to implement adaptations which allow the fuel cell 50 to continue operation after substantial degradation of the electrolyte membrane 58. This eliminates concerns related to emissions due to degradation of the electrolyte membrane 58 and balance of plant leakage which leaks into exhaust directly, as the controller 34 actively monitors such degradation/leakage and automatically implements adaptations to the operating parameters (air flow, transient load, opening/closing anode purge valve or drain valve, cathode bypass valve, isolation valve and backpressure valve) to compensate for degradation of the electrolyte membrane 58 and balance of plant leakage, to ensure that emissions from the fuel cell 50 are within accepted range.

Further, aspects of the fuel cell 50, fuel cell propulsion system 20 and method 200 of the present disclosure allow a fuel cell 50 to operate beyond established end-of-life parameters based on anode and balance of plant degradation/leakage (which leaks to exhaust directly) by actively monitoring and automatically detecting when degradation of the electrolyte membrane 58 and balance of plant leakage (which leaks to exhaust directly) is occurring and automatically implementing adaptations to the operating parameters of the fuel cell 50 to allow the fuel cell 50 to keep operating with acceptable emissions levels.

Finally, to the extent that such adaptations incur the cost of reduced fuel cell 50 performance (lower power output), an owner/operator of a vehicle having a fuel cell 50 or fuel cell propulsion system 20 in accordance with the teachings of the present disclosure will have the advantage of being able to selectively decide to either accept the reduced performance aspects of adaptations implemented by the controller 34, and thus, extend the life cycle of the fuel cell 50, or to, upon implementation of such adaptations by the controller 34, determine that the fuel cell 50 should be immediately repaired/replaced. This improves the overall customer experience by allowing the owner/operator to decide.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of controlling a hydrogen fuel cell, comprising:
with a controller of the fuel cell:
measuring an anode leak rate for the fuel cell;
modelling, using the measured anode leak rate, an effective electrolyte membrane orifice size;
calculating, using the effective electrolyte membrane orifice size, an effective runtime anode leak rate during operation of the fuel cell based on the current operating conditions;
using the effective runtime anode leak rate as a low-side metric when calculating emissions and dilution requests; and
initiating adaptations of a control strategy of the fuel cell based on one of:
the effective runtime anode leak rate; or
a shutdown leak rate.

2. The method of claim 1, wherein, the measuring an anode leak rate for the fuel cell further includes measuring an anode shutdown leak rate for the fuel cell.

3. The method of claim 1, wherein, the measuring an anode leak rate for the fuel cell further includes:
monitoring pressure decay within the anode during low-power operation of the fuel cell; and at least one of:
estimating the anode leak rate based on the pressure decay within the anode during low-power operation of the fuel cell; and
calculating the anode leak rate based on both anode pressure change and cathode pressure change.

4. The method of claim 1, wherein the initiating adaptations of the control strategy of the fuel cell based one of: the effective runtime anode leak rate or the shutdown leak rate further includes:
during start-up of the fuel cell, increasing a duration of increased air flow through a cathode of the fuel cell to dilute the concentration of hydrogen leaked from the anode;
wherein, anode to cathode bias pressure, air flow rate, air flow split and the duration of increased air flow are calculated and adjusted based on one of:
the effective runtime anode leak rate; or
the shutdown leak rate.

5. The method of claim 4, wherein the initiating adaptations of the control strategy of the fuel cell based on one of: the effective runtime anode leak rate or the shutdown leak rate further includes adapting, during run-time operation of the fuel cell, bleed request frequency to vent gas from the anode of the fuel cell.

6. The method of claim 5, wherein the initiating adaptations of the control strategy of the fuel cell based on one of the effective runtime anode leak rate or the shutdown leak rate further includes increasing, during run-time operation of the fuel cell, airflow through the cathode to compensate for the oxygen consumed by hydrogen gas that permeates through the electrolyte membrane.

7. The method of claim 6, wherein the initiating adaptations of the control strategy of the fuel cell based on one of: the effective runtime anode leak rate or the shutdown leak rate further includes limiting, during run-time operation of the fuel cell, transient load rates to control emissions during and after power load fluctuations.

8. The method of claim 4, wherein the initiating adaptations of the control strategy of the fuel cell based on one of: the effective runtime anode leak rate or the shutdown leak rate further includes, during run-time operation of the fuel cell, at least one of:
reducing bleed frequency;
increasing airflow through the cathode to compensate for the oxygen consumed by hydrogen gas that permeates through the electrolyte membrane; and
limiting transient load rates to control emissions during and after power load fluctuations.

9. The method of claim 8, wherein the initiating adaptations of the control strategy of the fuel cell based on one of: the effective runtime anode leak rate or the shutdown leak rate further includes, during a shutdown operation of the fuel cell:
venting hydrogen gas from the anode and the cathode directly to exhaust; and
reducing the anode and cathode pressure.

10. The method of claim 9, wherein the initiating adaptations of the control strategy of the fuel cell based on one of: the effective runtime anode leak rate or the shutdown leak rate further includes, during a freeze start operation of the fuel cell, reducing bias pressure between the anode and the cathode.

11. The method of claim 10, wherein the initiating adaptations of the control strategy of the fuel cell based on one of: the effective runtime anode leak rate or the shutdown leak rate further includes:
during a stand-by operation of the fuel cell, continuously, on a periodic basis, monitoring pressure decay within the anode; and
during an extended period of non-use, initializing H2-in-park measures to ensure that sufficient hydrogen gas remains present within the anode and cathode for a start-up operation when pressure decay within the anode indicates that oxygen has leaked into the anode.

12. The method of claim 11, further including updating the measured anode leak rate whenever power output of the fuel cell is zero.

13. A fuel cell, comprising:
an anode, a cathode, an electrolyte membrane positioned between the anode and the cathode; and
a controller adapted to:
measure an anode leak rate for the fuel cell and update the measured anode leak rate whenever power output of the fuel cell is zero;
model, using the measured anode leak rate, an effective electrolyte membrane orifice size;
calculate, using the effective electrolyte membrane orifice size, an effective runtime anode leak rate during operation of the fuel cell;
use the effective runtime anode leak rate as a low-side metric when calculating emissions and dilution requests; and
initiate adaptations of a control strategy of the fuel cell based on one of:
the effective runtime anode leak rate; or
a shutdown leak rate.

14. The fuel cell of claim 13, wherein, when measuring the anode leak rate for the fuel cell, the controller is further adapted to measure an anode shutdown leak rate for the fuel cell.

15. The fuel cell of claim 14, wherein, when measuring the anode leak rate for the fuel cell, the controller is further adapted to:
monitor pressure decay within the anode during low-power operation of the fuel cell; and
estimate the anode leak rate based on the pressure decay within the anode during low-power operation of the fuel cell.

16. The fuel cell of claim 15, wherein, when initiating adaptations of the control strategy of the fuel cell based on one of: the effective runtime anode leak rate or the shutdown leak rate, the controller is further adapted to:
during start-up of the fuel cell, increase a duration of increased air flow through a cathode of the fuel cell to dilute the concentration of hydrogen leaked from the anode;
wherein, anode to cathode bias pressure, air flow rate, air flow split and the duration of increased air flow are calculated based on one of: the effective runtime anode leak rate or the shutdown leak rate.

17. The fuel cell of claim 4, wherein, when initiating adaptations of the control strategy of the fuel cell based on one of the effective runtime anode leak rate or the shutdown leak rate, the controller is further adapted to, during run-time operation of the fuel cell, at least one of:
reduce bleed frequency;
increase airflow through the cathode to compensate for the oxygen consumed by hydrogen gas that permeates through the electrolyte membrane; and
limit transient load rates to control emissions during and after power load fluctuations.

18. The fuel cell of claim 17, wherein, when initiating adaptations of the control strategy of the fuel cell based on one of the effective runtime anode leak rate or the shutdown leak rate, the controller is further adapted to, during a shutdown operation of the fuel cell:
vent hydrogen gas from the anode and the cathode directly to exhaust; and
reduce the anode and cathode pressure.

19. The fuel cell of claim 9, wherein, when initiating adaptations of the control strategy of the fuel cell based on one of: the effective runtime anode leak rate or the shutdown leak rate, the controller is further adapted to:
during a freeze start operation of the fuel cell, reduce bias pressure between the anode and the cathode; and
during extended period of non-use of the fuel cell, continuously, on a periodic basis, monitor pressure decay within the anode, and initialize H2-in-park measures to ensure that sufficient hydrogen gas remains present within the anode for a start-up operation when pressure decay within the anode indicates that oxygen has leaked into the anode.

20. A vehicle having a fuel cell propulsion system including a fuel cell, the fuel cell, comprising:
an anode, a cathode, an electrolyte membrane positioned between the anode and the cathode; and
a controller adapted to:
measure an anode leak rate for the fuel cell and update the measured anode leak rate whenever power output of the fuel cell is zero by one of:
measuring an anode shutdown leak rate for the fuel cell; or
monitor pressure decay within the anode during low-power operation of the fuel cell, and estimate the anode leak rate based on the pressure decay within the anode during low-power operation of the fuel cell;
model, using the measured anode leak rate, an effective electrolyte membrane orifice size;
calculate, using the effective electrolyte membrane orifice size, an effective runtime anode leak rate during operation of the fuel cell;
use the effective runtime anode leak rate as a low-side metric when calculating emissions and dilution requests; and
initiate adaptations of a control strategy of the fuel cell based on one of:
the effective runtime anode leak rate; or
a shutdown leak rate by at least one of:
during start-up of the fuel cell, increase a duration of increased air flow through the fuel cell to dilute the concentration of hydrogen leaked from the anode, wherein, anode to cathode bias pressure, air flow rate, air flow split and the duration of increased air flow are calculated based on the effective runtime anode leak rate or shutdown leak rate;
during run-time operation of the fuel cell, adjust bleed frequency to vent hydrogen gas from the anode of the fuel cell;
during run-time operation of the fuel cell, increase airflow through the cathode to compensate for the oxygen consumed by hydrogen gas that permeates through the electrolyte membrane;
during run-time operation of the fuel cell, limit transient load rates to control emissions during and after power load fluctuations;
during a shutdown operation of the fuel cell, vent hydrogen gas from the anode and the cathode directly to exhaust with dilution, and reduce the amount of H2 in both the anode and the cathode;
during a freeze start operation of the fuel cell, reduce bias pressure between the anode and the cathode; and
during a stand-by operation of the fuel cell, continuously, on a periodic basis, monitor pressure decay within the anode, updating the measured anode shutdown leak rate whenever power output of the fuel cell is zero; and
during long off-time, initialize H2-in-park measures to ensure that sufficient hydrogen gas remains present within the anode for a start-up operation when pressure decay within the anode indicates that oxygen has leaked into the anode.
